(19) United States
(12) Patent Application Publication
(10) Pub. No.: US 2015/0169911 A1
(43) Pub. Date: Jun. 18, 2015

(54) POSITION LOCATION SYSTEM ARCHITECTURE: FILTERING POSITION FIXES

(71) Applicant: QUALCOMM Incorporated, San Diego, CA (US)

(72) Inventors: Bin Tian, San Diego, CA (US); Ahmad Jalali, Rancho Santa Fe, CA (US)

(73) Assignee: QUALCOMM Incorporated, San Diego, CA (US)

(21) Appl. No.: 14/106,548

(22) Filed: Dec. 13, 2013

(51) Int. Cl. G06K 7/10

(52) U.S. Cl. CPC G06K 7/10366

(57) ABSTRACT

A method of determining a position location of an asset tag within an indoor position location system includes filtering a history of locations of an asset tag within the indoor position location system. Such a method further includes computing, based on the history, a likelihood that the asset tag is in a predetermined room of the indoor position location system.

### FIELD

Aspects of the present disclosure relate generally to wireless communication systems, and more particularly to a position location architecture.

### BACKGROUND

Wireless networks are widely deployed to provide various communication services such as voice, video, packet data, messaging, broadcasting and other like wireless communication services. These wireless networks may be multiple-access networks capable of supporting multiple users by sharing the available network resources. In a wireless local area network (WLAN), an access point supports communication for a number of wireless stations within the wireless network. In an ad-hoc mode, the wireless stations (“peer nodes”) communicate in a peer-to-peer (P2P) manner without an access point. Similarly, a peer-to-peer network allows the peer nodes to directly communicate with one another. In a peer-to-peer network, peer-to-peer nodes within range of one another discover and communicate directly without an access point.

A positioning system may refer to a network of devices used to wirelessly locate objects or people. An example of a positioning system is an indoor positioning system (IPS) which may locate objects or people inside a building. Instead of using a satellite positioning system (SPS), an IPS may rely on nearby nodes that actively locate tags.

### SUMMARY

A method of determining a position location of an asset tag within an indoor position location system in accordance with an aspect of the present disclosure includes filtering a history of locations of an asset tag within the indoor position location system. Such a method further includes computing, based on the history, a likelihood that the asset tag is in a predetermined room of the indoor position location system.

An apparatus within a position location system in accordance with another aspect of the present disclosure includes means for filtering a history of locations of an asset tag within the indoor position location system. Such an apparatus further includes means for computing, based on the history, a likelihood that the asset tag is in a predetermined room of the indoor position location system.

An apparatus in accordance with yet another aspect of the present disclosure includes a memory and at least one processor. The processor(s) is configured to filter a history of locations of an asset tag within the indoor position location system. The processor(s) is further configured to compute, based on the history, a likelihood that the asset tag is in a predetermined room of the indoor position location system.

A computer program product configured for wireless communication in a position location system in accordance with a further aspect of the present disclosure includes a non-transitory computer-readable medium having program code recorded thereon. The program code includes program code to filter a history of locations of an asset tag within the indoor position location system. The program code also includes program code to compute, based on the history, a likelihood that the asset tag is in a predetermined room of the indoor position location system.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates a diagram of a communication system according to one aspect of the disclosure.

FIG. 2 is a block diagram illustrating an exemplary hardware configuration of wireless nodes used in the communication system, such as the position location system illustrated in FIG. 4.

FIG. 3 illustrates a diagram of a peer-to-peer network according to one aspect of the disclosure.

FIGS. 4-6 are a diagram illustrating position location systems according to various aspects of the disclosure.

FIG. 7 is a flow chart illustrating a method in accordance with an aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts. As described herein, the use of the term “and/or” is intended to represent an “inclusive OR”, and the use of the term “or” is intended to represent an “exclusive OR”.

In one aspect of the disclosure, a position location system tracks the location of assets (e.g., users) using a device that may be worn by an asset, referred to herein as an “asset tag.” The asset tag may support wireless node functionality (e.g., a wireless station and/or a wireless node of a peer-to-peer network), or other like radio access technology. It should be recognized that asset tag operation to enable the position location system may be incorporated into a wireless handheld device of a user. Although the asset tags may be specified as stations, aspects of the disclosure also relate to ad-hoc and/or peer-to-peer network implementations in which wireless peer nodes and/or wireless stations discover and communicate directly without access points. A wireless station can be a dedicated access point or a temporary access point (e.g., a soft access point) configured for access point functionality, for example, when operating according to a wireless local area network (WLAN) infrastructure mode. In a WLAN ad-hoc mode, or peer-to-peer network, the wireless stations/peer nodes discover and communicate directly without an access point.

In one aspect of the disclosure, the asset tags transmit known preambles that are received by multiple access points (APs). The access points may estimate and send a time of arrival (TOA) of the preamble from a specific asset tag to a position location server. The position location server processes received TOAs from the multiple access points to estimate the position of the asset tags. In another configuration, the access points transmit a known beacon signal that is received by all asset tags in the respective coverage area of the access points. In this configuration, the asset tags make time difference of arrival (TDOA) measurements from the received beacon signals from different access points. The asset tags may compute their position based on the TDOA measurements or send the TDOA measurements to a position location server (PLS) for position location computation.

One configuration of the position location system involves determining whether a particular asset/person is within a room in a building or within a location that has several different partitions separating positions in the location (e.g., floors in a structure, separate courts in a sports complex, etc.) The asset tags, however, may move as a person moves within a room or partitioned location without leaving a particular room. Thus the positioning system may determine accuracy to within one partition or another. One aspect of the present disclosure provides methods and apparatuses to resolve, or filter, any discrepancies in asset tag position determination. Such discrepancies may show that the asset has moved from one partitioned location to another by passing through a partition or otherwise contains positioning errors.

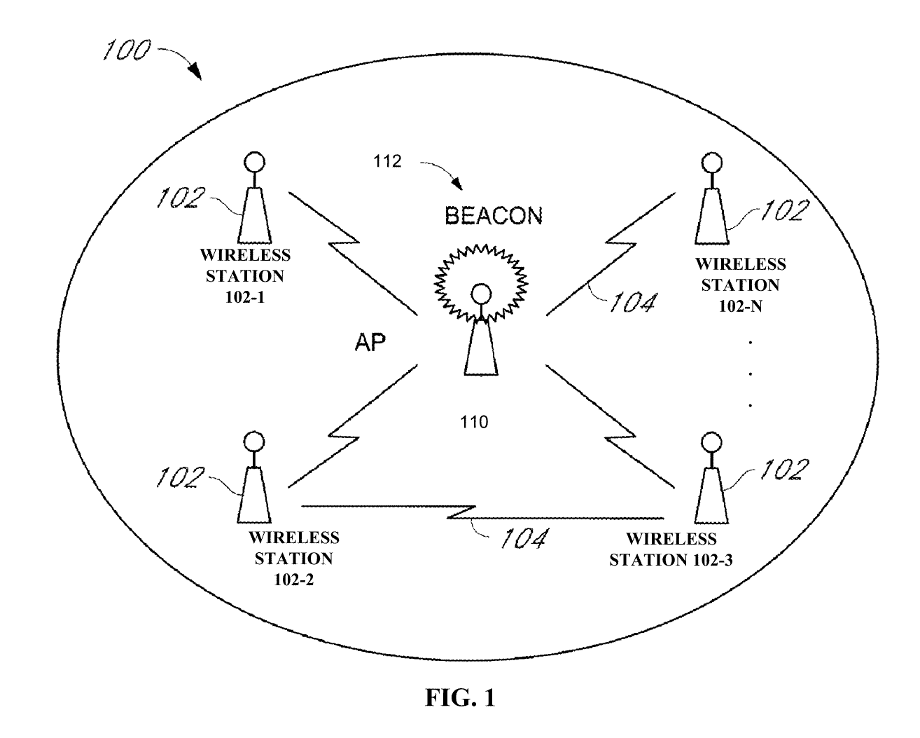

For example, the position of an asset/person within the position location system may be identified as being in the wrong room. For example, the wrong room is identified when the asset/person is close to the walls of the room and the position location error is larger than the distance between the asset/person and the wall. The wrong room may also be determined due to slight movements when the asset tag is in a person's cellular telephone and moves as the person moves about the room. One aspect of the present disclosure filters similar positioning errors in a number of ways to ensure that the asset tag's position is properly reported. The position location system may be implemented in various wireless networks, such as the WLAN configuration shown in FIG. 1.

System Overview

One example of a wireless communication system 100 is illustrated in FIG. 1. The wireless communication system 100 may include a number of wireless stations 102 (102-1 . . . 102-N) and access points 110 that can communicate with one another over wireless links 104. Although the wireless communication system 100 is illustrated with five wireless stations/access points 102/110, it should be appreciated that any number of stations and access points (wired or wireless) may form the wireless communication system 100. In the illustration, the access points 110 are dedicated access points. Alternatively, the access points 110 may be configured for access point functionality (e.g., as a soft access point).

The wireless stations/access points 102/110 may be any device configured to send and receive wireless communications, such as a laptop computer, Smartphone, a printer, a personal digital assistant, a camera, a cordless telephone, a session initiation protocol phone, a handheld device having wireless connection capability, a user equipment, an access terminal, or any other suitable device. In one aspect of the disclosure, the wireless stations/access points 102/110 are incorporated into a tag that is placed on an asset (e.g., a user). In the wireless communication system 100, the wireless stations/access points 102/110 may be distributed throughout a geographic region. Further, each wireless station/access point 102/110 may have a different coverage region over which it may communicate. The access points 110 may include or be implemented as a base station, a base transceiver station, a terminal, a wireless node operating as an access point, or the like. The wireless stations/access points 102/110 in the wireless communication system 100 may communicate wirelessly using any suitable wireless network standard.

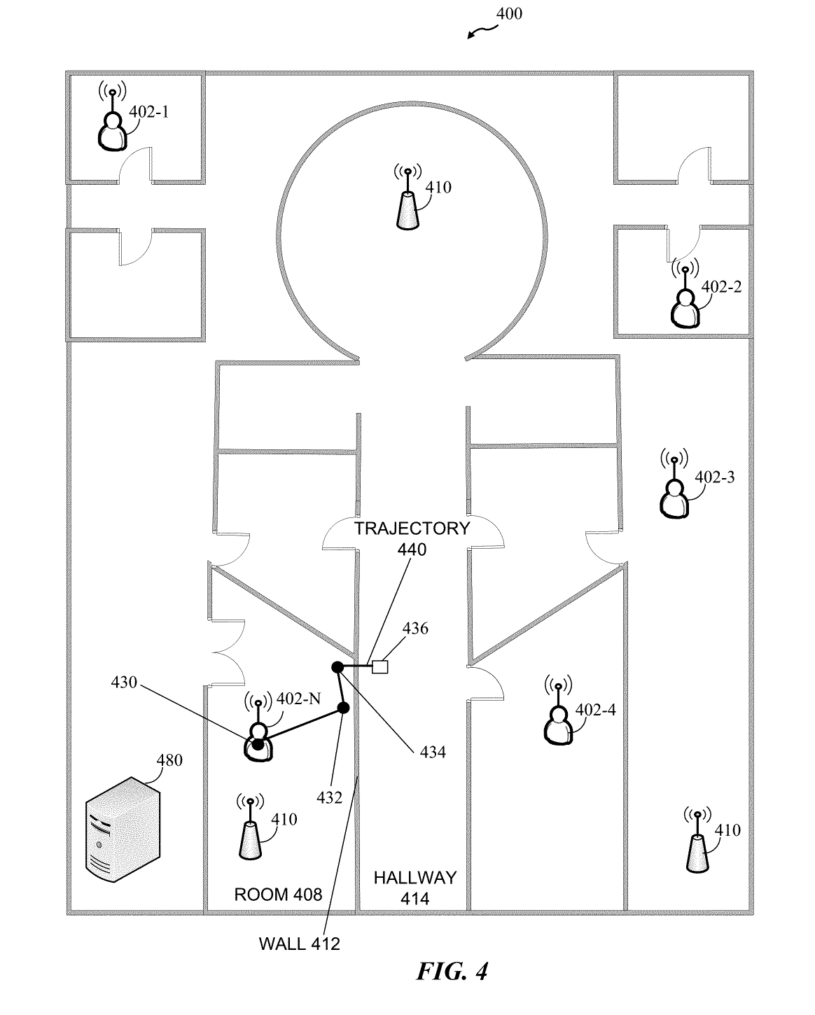

In one configuration, an asset tag may be configured as one of the wireless stations 102 that associates with one of the access points 110 to send and/or receive position information from one of the access points 110 according to an initial wireless access message 112 (e.g., beacon) broadcast by one of the access points 110. In one aspect of the disclosure, the asset tags measure beacon signals from access points 110 and compute an asset tag position. Alternatively, the asset tags transmit the beacon measurements to a position location server. In another configuration, the asset tags transmit known preambles that are received by the access points 110. The access points 110 may estimate and send the time of arrival (TOA) of the preamble from a specific tag to the position location server that estimates the position of the asset tags. Position location computations may be carried out at the position location server using the TOAs and/or TDOAs received from the different access points 110, for example, as shown in FIG. 4.

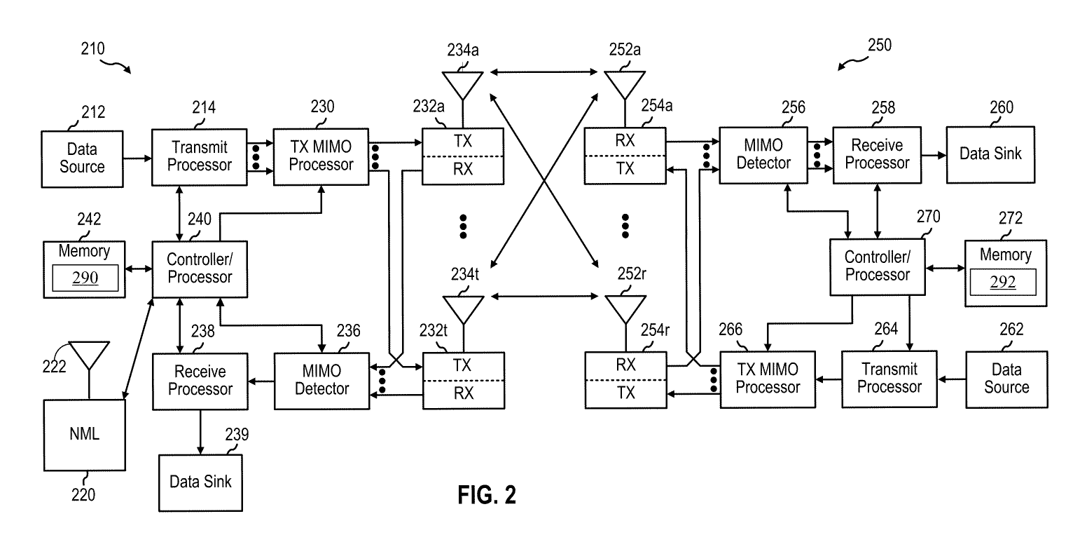

FIG. 2 shows a block diagram of a design of an access point 210 and a wireless station 250, each of which may be one of the wireless nodes in FIGS. 1, 3, and 4. Each of the wireless nodes in the wireless communication system 100 may include a wireless transceiver to support wireless communication and controller functionality to manage communication over the network. The controller functionality may be implemented within one or more digital processing devices. The wireless transceiver may be coupled to one or more antennas to facilitate the transmission and reception of signals over a wireless channel.

In one configuration, the access point 210 may be equipped with antennas 234 (234a, . . . , 234t), and the wireless station 250 may be equipped with antennas 252 (252a, . . . , 252r).

At the access point 210, a transmit processor 214 may receive data from a data source 212 and control information from a controller/processor 240. The transmit processor 214 may process (e.g., encode and symbol map) the data and control information to obtain data symbols and control symbols, respectively. The transmit processor 214 may also generate reference symbols, and cell-specific reference signal. A transmit (TX) multiple-input multiple-output (MIMO) processor 230 may perform spatial processing (e.g., precoding) on the data symbols, the control symbols, and/or the reference symbols, if applicable, and may provide output symbol streams to the transceivers 232 (232a, . . . , 232t). Each of the transceivers 232 may process a respective output symbol stream to obtain an output sample stream. Each of the transceivers 232 may further process (e.g., convert to analog, amplify, filter, and upconvert) the output sample stream to obtain a transmission signal. Signals from transceivers 232 may be transmitted via the antennas 234 (234a, . . . , 234t), respectively.

At the wireless station 250, the antennas 252 (252a, . . . , 252r) may receive the signals from the access point 210 and may provide received signals to the transceivers 254 (254a, . . . , 254r), respectively. Each of the transceivers 254 may condition (e.g., filter, amplify, downconvert, and digitize) a respective received signal to obtain input samples. Each of the transceivers 254 may further process the input samples to obtain received symbols. A MIMO detector 256 may obtain received symbols from all of the transceivers 254, perform MIMO detection on the received symbols if applicable, and provide detected symbols. A receive processor 258 may process (e.g., demodulate, deinterleave, and decode) the detected symbols, provide decoded data for the wireless station 250 to a data sink 260, and provide decoded control information to a controller/processor 270.

When transmitting, from the wireless station 250, a transmit processor 264 may receive and process data from a data source 262 and control information from the controller/processor 270. The transmit processor 264 may also generate reference symbols for a reference signal. The symbols from the transmit processor 264 may be precoded by a TX MIMO processor 266 if applicable, further processed by the transceivers 254, and transmitted to the access point 210. At the access point 210, the signals received from the wireless station 250 may be received by the antennas 234, processed by the transceivers 232, detected by a MIMO detector 236 if applicable, and further processed by a receive processor 238 to obtain decoded data and control information sent by the wireless station 250. The receive processor 238 may provide the decoded data to a data sink 239 and the decoded control information to the controller/processor 240. The access point 210 can send messages to other base stations, for example, over a backhaul link. In one configuration, the access point includes a narrowband messaging link (NML) 220 having an antenna 222 for enabling synchronization and ranging initialization between asset tags and access points of an indoor position location system, for example, as shown in FIG. 4. It should be recognized that the wireless station 250 may also be configured to include a narrowband message link, such as the narrowband messaging link 220 of the access point 210, although it is not shown.

The controller/processor 240 may direct the operation at the access point 210 and the controller/processor 270 may direct the operation at wireless station 250, respectively. The controller/processor 270 and/or other processors and modules at the wireless station 250 may perform or direct the execution of the functional blocks illustrated in method flow charts of FIGS. 4, 5 and 6 and/or other processes for the techniques described herein. The memory 242 may store data and program codes for the access point 210 and the memory 272 may store data and program codes for the wireless station 250. For example, the memory 272 of the wireless station 250 may store a position location module 292 which, when executed by the controller/processor 270, configures the wireless station 250 for operation within a position location system, for example, as shown in FIG. 4. Similarly, the memory 242 of the access point 210 may store a position location module 290 which, when executed by the controller/processor 240, configures the access point 210 for operation within the position location system shown in FIG. 4.

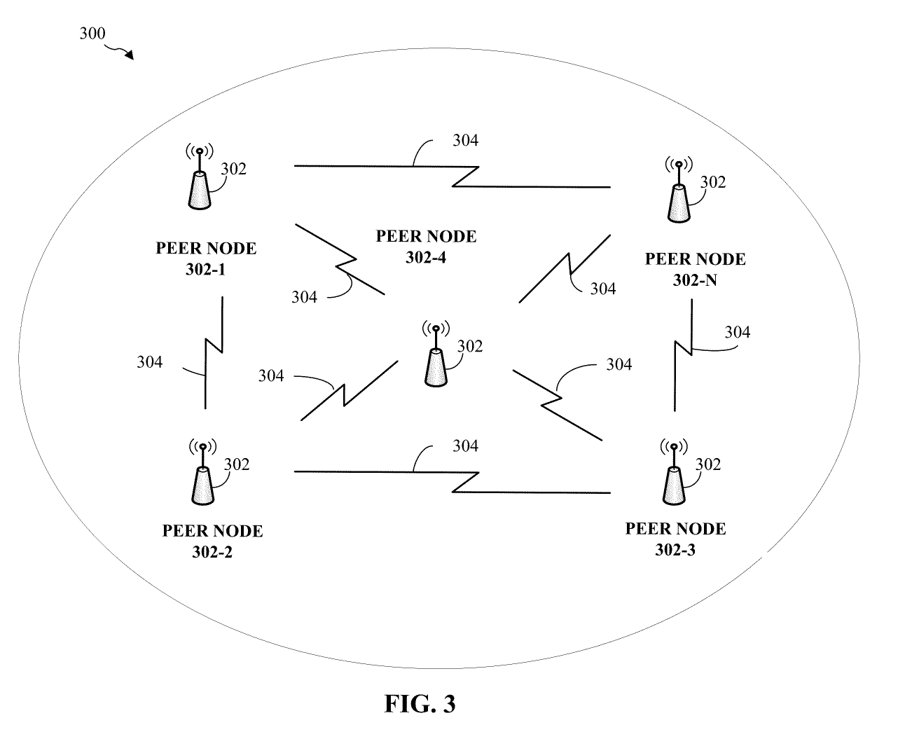

FIG. 3 illustrates a diagram of a peer-to-peer network 300 according to one aspect of the disclosure. In some aspects, the peer-to-peer network 300 may be established between two or more peer nodes 302 (302-1, 302-2, 302-3, 302-4, . . . 302-N). The peer nodes 302 in the peer-to-peer network 300 may communicate wirelessly using any suitable wireless network standard. The peer-to-peer network 300 may include a number of the peer nodes 302 that can communicate with one another over wireless links 304. An asset tag may be configured according to the wireless station 250 of FIG. 2, and operate as one of the peer nodes 302 of the peer-to-peer network 300.

For example, an asset tag that operates as one of the peer nodes 302-1 may associate with another of the peer nodes 302-4 to transmit known preambles that are received by the peer nodes 302. One of the peer nodes 302-1 may estimate and send the time of arrival (TOA) of the preamble from a specific asset tag to a position location server (not shown) that estimates the position of the asset tags. Position location computations may be carried out at the position location server using the TOAs received from the different peer nodes 302. In another configuration, the peer nodes 302 transmit a known beacon signal, which is typically a wide bandwidth beacon signal, which is received by all asset tags in the respective coverage area of the peer nodes. In this configuration, the asset tags make TOA and/or TDOA measurements on the received beacon signals from different peer nodes 302 and either compute the position at the asset tag or send the measurements to the position location server for position location computation.

An asset tag may be any device configured to send and receive wireless communications, such as a laptop computer, a smartphone, a printer, a personal digital assistant, a camera, a cordless telephone, a session initiation protocol phone, a handheld device having wireless connection capability, a user equipment, an access terminal, or any other suitable device that may be worn as an asset tag.

Positioning System Diagram

FIG. 4 is a diagram illustrating a position location system 400 according to one aspect of the disclosure. The position location system 400 may track assets (e.g., people) using the asset tags 402 (402-1, . . . , 402-N) that people wear. The asset tags 402 may be configured according to the wireless station 250 of FIG. 2 to support wireless node functionality (e.g., wireless stations and/or a wireless nodes of a peer-to-peer network), or other like radio access technology.

As shown in FIG. 4, the position location system 400 includes the asset tags 402, access points (APs) 410 installed on the premises, and a position location server 480 that estimates the position of the asset tags 402. In one configuration, the asset tags 402 transmit known preambles that are received by the access points 410. The access points 410 may estimate and send the time of arrival (TOA) of the preamble from a specific asset tag to the position location server 480. Position location computations may be carried out at the position location server 480 using the TOAs received from the different access points 410. This approach may help reduce the power consumption at the asset tags 402.

In another configuration, the access points 410 transmit a known beacon signal, which is received by all the asset tags 402 in the respective coverage area of the access points 410. In this configuration, the asset tags 402 make TOA measurements based on the received beacon signals (also referred to as “pilots”) from the different access points 410. The asset tags 402 may either compute the position at one of the asset tags 402 or send the measurements to the position location server 480 for position location computation. In the configuration where the asset tags 402 measure the beacon signals from the access points 410 and compute their respective position without the position location server 480, higher power consumption at the asset tags 402 may lower battery life.

Filtering Position Fixes

In an aspect of the present disclosure, the position location system 400 tracks an asset/person with room level accuracy (e.g., the actual room where the asset/person resides). The use of wideband signals in the position location system 400 may cause a ranging error which is a function of the bandwidth of the ranging signals and the signal to noise ratio (SNR) at the receiver (e.g., at the asset tags 402). The ranging error may also include any multi-path interference created by the objects/structures around the asset tags 402 and the access points 410 of the system.

This position location error may cause misidentification of the positions of the asset tags 402 and, thus, misidentification of the location of the asset/person associated with that asset tag 402. The position location system 400 is aware of the boundaries of rooms, regions, or areas within a geographical area through, for example, programming or other data stored in the position location server 480, or through software, hardware, or other means located in the position location system 400. For example, the position of an asset/person may be identified as being in the wrong room when the asset/person is close to barriers (e.g., walls) of a given room and the position location error for the asset tag 402 is larger than the distance between the asset/person and the wall/barrier. The wrong room may also be determined due to slight movements when the asset tag 402 is in a person's cellular telephone and moves as the person moves about the room. One aspect of the present disclosure filters positioning errors in a number of ways to ensure that the asset tag's position is properly reported.

In FIG. 4, the access points 410-1 and 410-2 send beacon signals to the asset tags 402-1 through 402-N. For ease of explanation, the asset tag 402-N will be discussed, although it is understood that similar discussions may be applied to any asset tag 402 in the position location system 400.

In an aspect of the present disclosure, a past history of the locations of a given asset tag 402 are filtered and/or analyzed. Based on the past history, a likelihood that an asset tag 402 is in a given room may be computed. For example, the asset tag 402-N may have had previous position fixes 430, 432, and 434, all of which are in the room 408. A current position fix within the room 408 may be determined for the asset tag 402-N.

In another aspect of the present disclosure, the consecutive locations computed by the position location server 480 are connected to create a trajectory 440 of the asset tag's movements. For example, the trajectory 440 of the past position fixes of the asset tag 402 may imply that the asset tag 402 passed through a barrier, e.g., wall 412, to reach a current position 436 determined by the position location server 480 as the final position of the asset tag 402-N. When the positioning fix occurs frequently enough (high enough that the distance travelled between fixes is not enough for the tag to actually leave through one door and enter another room through another door), most likely the error in the final position fix has placed the asset tag 402 in the wrong room. In this example, the position location server 480 would then place the asset tag 402-N in the room 408 rather than in a hallway 414.

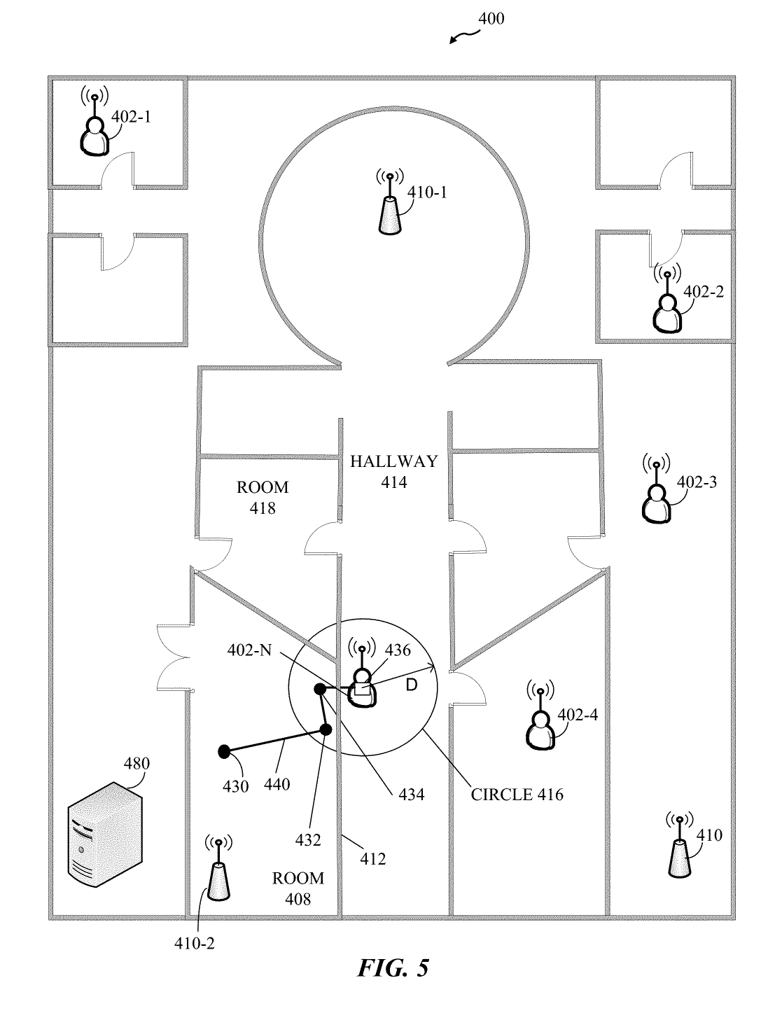

FIG. 5 is a diagram illustrating the position location system 400 according to another aspect of the disclosure. Another configuration of the position location system 400 improves position fix accuracy by defining an area around an asset tag. For example, assume the accuracy of the position location system 400 is such that p % of the time the position location error is less than d meters, where p % may be taken to be, for example, 95%. In this configuration, an area (e.g., circle 416) of radius D, or other area having any shape, is drawn around the computed, final position of the asset tag 402-N. Next, the number of rooms within the position location system 600 that intersect the circle 416 is determined. When the list includes only one region or room (e.g., the room 408) and the trajectory of the past positions of the asset tag 402-N do not pierce through the wall 412 to end up in a position anywhere in the circle 416, the room in the list is associated with the asset tag 402.

In another aspect of the present disclosure, the list contains more than one room (e.g., the room 408, the hallway 414, and a room 418 as shown in FIG. 5) or the trajectory 440 of the past positions of the asset tag pierces through a barrier (e.g., the wall 412) to arrive at the final position estimate in a room. In this example, a probability for the asset tag's location may be computed for each room within the circle 416 to determine the room in which the asset tag 402-N is located. The location of the asset tag 402-N may be chosen based on the room with the highest probability. The circle 416 determines all rooms that have a likelihood of greater than p %. As shown in FIG. 5, the room 418 has the lowest likelihood since the smallest portion of the circle 416 is within the room 418. Although the largest portion of the circle 416 is within the hallway 414, the trajectory 440 traverses the wall 412, which may affect the calculation of the final position of the asset tag 402-N. Nevertheless, using the circle 416 along with the trajectory 440, or the other previous position fixes 430, 432, 434 and 436, may change the probability that the asset tag 402-N is in the room 408 as opposed to the hallway 414 or the room 418.

For example, the trajectory 440 connects all the past estimated position fixes 430, 432, 434 of the asset tag 402-N. A possible likelihood metric may be the sum of all sections of the trajectory 440 that fall in each room in the circle 416. In this example, the position of the asset tag 402-N may be chosen based on the room with the largest metric. The actual position of the asset tag 402-N, however, may not be on the trajectory 440 due to an error in the position location estimation scheme. To account for the error in the position estimate relative to the actual position of the asset tag 402-N, one configuration of the present disclosure may also define a region around the trajectory to include all points of the actual tag position.

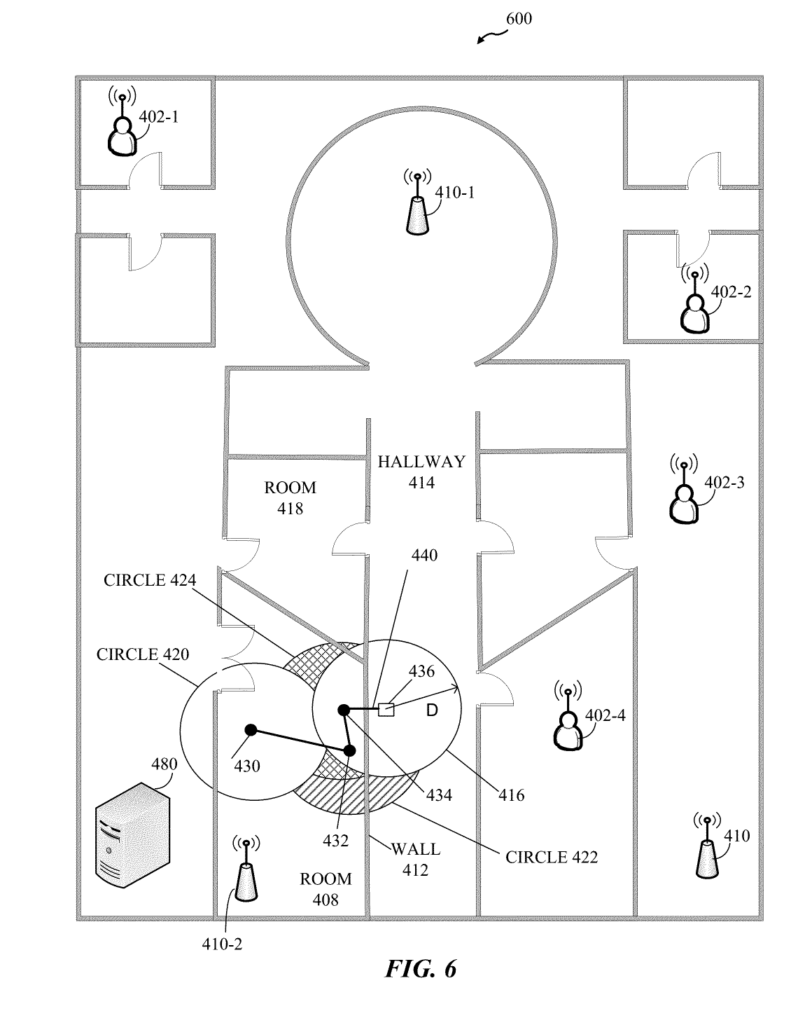

FIG. 6 illustrates another configuration for reducing the probability of associating the asset tag 402-N with the wrong room. Again, using the circle 416 with radius D around the estimated position 436 of the asset tag 402-N, the actual position of the asset tag 402-N may be determined with a probability of at least p, where p may be chosen to be 0.95. Now, a configuration may be used that defines the tag probable positions (TaPP) area as a set of all points formed by a union of all circles of radius d (or other areas) around the position fixes 430, 432, 434, and 436 on the trajectory 440 line connecting consecutive position fixes. The areas formed around each of the position fixes 430-436 may vary based on a number of variables, e.g., length of time between position fixes, relative certainty of each position fix, etc. However, for ease of explanation in FIG. 6, a circle 420 is a circle of radius D around the position fix 430, a circle 422 is a circle of radius D around the position fix 432, and a circle 424 is a circle of radius D around the position fix 434. Using the consecutive (in time) circles 416, 420, 422, and 424 on the trajectory 440, a metric can be computed. For each of the rooms in the list that intersect the consecutive circles 416, 420, 422, 424, metric mᵢ(l) may be computed as follows:

mᵢ(l)=∫∫p(x,y)dxdy (1)

where l represents the l-th segment of the trajectory 440 that at least partially falls inside a room and i is the index of the room. Integration is over a portion of the two dimensional area TaPP of the l-th trajectory that falls on room i. The value p(x,y) represents a probability density of position of the tag within the TaPP area.

The i-th room metric mᵢ may be computed by summing over all mᵢ(l) of the trajectory 440 that fall inside the i-th room, or a filtered version of all mᵢ(l). The room i with the largest metric, mᵢ, may be associated with the asset tag 402-N. When none of the metrics exceed a certain threshold, an error flag may be raised that the room association is not highly reliable. Note that the trajectory 440 may loop back as the asset tag 402-N may be moving around and/or due to the error in position fixes. Therefore, the area computation is carried out in a piecewise fashion on the circles 416, 420. 422, and 424 between consecutive position fixes.

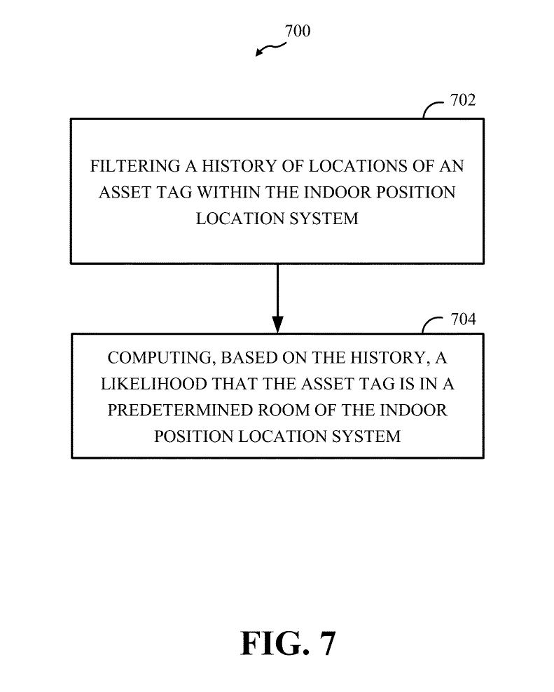

FIG. 7 is a flow chart illustrating a method 700 for filtering position fixes in accordance with an aspect of the present disclosure. In block 702 a history of locations of an asset tag within the indoor position location system is filtered. For example, as illustrated in FIG. 6, the position fixes 430, 432, 434, and 436 of an asset tag 402-N are filtered. In block 704, a likelihood that the asset tag is in a predetermined room of the indoor position location system is computed based on the history. For example, the trajectory 440 of the past position fixes of the asset tag 402 may imply that the asset tag 402 passed through a wall 412 to reach the current position 436 determined by the position location server 480 as the final position of the asset tag 402-N. In this scenario, the final position of the asset tag 402-N is in the wrong room. In this example, the position location server 480 would then place the asset tag 402-N in the room 408 rather than in the hallway 414.

In one configuration, a position location system includes a means for filtering a past history of locations of a given tag of the position location system. In one aspect of the disclosure, the filtering means may be controller/processor 240, controller/processor 270 or other means configured to perform the functions recited by the filtering means. In this configuration, the position location system also includes a means for computing, based on the past history, a likelihood that the given tag is in a predetermined room of the position location system. In one aspect of the disclosure, the estimating means may be the controller/processor 240, 270 or other means configured to perform the functions recited by the computing means. In another aspect, the aforementioned means may be any module or any apparatus configured to perform the functions recited by the aforementioned means.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, one or more microprocessors, one or more microprocessors in conjunction with a DSP core, or any other such configuration.

The steps of a method or algorithm described in connection with the disclosure may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method of determining a position location of an asset tag within an indoor position location system, comprising:
filtering a history of locations of the asset tag within the indoor position location system; and
computing, based on the history, a likelihood that the asset tag is in a predetermined room of the indoor position location system.

2. The method of claim 1, further comprising:
determining a trajectory of the asset tag's movements from consecutive locations in the history; and
detecting an erroneous position of the asset tag when the trajectory of the asset tag's movements indicates the asset tag has moved through a barrier to reach the predetermined room.

3. The method of claim 2, further comprising:
computing a list of rooms in which the asset tag may be located according to an area around a final position of the asset tag; and
determining the asset tag is in the predetermined room when the list of rooms includes one room and the trajectory does not pass through the barrier to reach the predetermined room.

4. The method of claim 2, further comprising:
computing a list of rooms in which the asset tag may be located according to an area around a final position of the asset tag;
computing a likelihood that the asset tag may be in each room when either the trajectory passes through the barrier or the list includes a plurality of rooms; and
selecting the predetermined room from the list based at least in part on the likelihoods.

5. The method of claim 4, in which the likelihood is based at least in part on a sum of portions of the area that are located within each room.

6. The method of claim 4, in which the likelihood is based at least in part on a region around the trajectory.

7. An apparatus within a position location system, comprising:
means for filtering a history of locations of an asset tag within an indoor position location system; and
means for computing, based on the history, a likelihood that the asset tag is in a predetermined room of the indoor position location system.

8. The apparatus of claim 7, further comprising:
means for determining a trajectory of the asset tag's movements from consecutive locations in the history; and
means for detecting an erroneous position of the asset tag when the trajectory of the asset tag's movements indicates the asset tag has moved through a barrier to reach the predetermined room.

9. The apparatus of claim 8, further comprising:
means for computing a list of rooms in which the asset tag may be located according to an area around a final position of the asset tag; and
means for determining the asset tag is in the predetermined room when the list of rooms includes one room and the trajectory does not pass through the barrier to reach the predetermined room.

10. The apparatus of claim 8, further comprising:
means for computing a list of rooms in which the asset tag may be located according to an area around a final position of the asset tag;
means for computing a likelihood that the asset tag may be in each room when either the trajectory passes through the barrier or the list includes a plurality of rooms; and
means for selecting the predetermined room from the list based at least in part on the likelihoods.

11. The apparatus of claim 10, in which the likelihood is based at least in part on a sum of portions of the area that are located within each room.

12. The apparatus of claim 10, in which the likelihood is based at least in part on a region around the trajectory.

13. An apparatus within a position location system, comprising:
a memory; and
at least one processor coupled to the memory and configured:
to filter a history of locations of an asset tag within an indoor position location system; and
to compute, based on the history, a likelihood that the asset tag is in a predetermined room of the indoor position location system.

14. The apparatus of claim 13, in which the at least one processor is further configured to determine a trajectory of the asset tag's movements from consecutive locations in the history; and
to detect an erroneous position of the asset tag when the trajectory of the asset tag's movements indicates the asset tag has moved through a barrier to reach the predetermined room.

15. The apparatus of claim 14, in which the at least one processor is further configured to compute a list of rooms in which the asset tag may be located according to an area around a final position of the asset tag; and
to determine the asset tag is in the predetermined room when the list of rooms includes one room and the trajectory does not pass through the barrier to reach the predetermined room.

16. The apparatus of claim 14, in which the at least one processor is further configured to compute a list of rooms in which the asset tag may be located according to an area around a final position of the asset tag;
to compute a likelihood that the asset tag may be in each room when either the trajectory passes through the barrier or the list includes a plurality of rooms; and
to select the predetermined room from the list based at least in part on the likelihoods.

17. The apparatus of claim 16, in which the likelihood is based at least in part on a sum of portions of the area that are located within each room.

18. The apparatus of claim 16, in which the likelihood is based at least in part on a region around the trajectory.

19. A computer program product configured for wireless communication in a position location system, the computer program product comprising:
a non-transitory computer-readable medium having program code recorded thereon, the program code comprising:
program code to filter a history of locations of an asset tag within an indoor position location system; and
program code to compute, based on the history, a likelihood that the asset tag is in a predetermined room of the indoor position location system.

20. The computer program product of claim 19, further comprising program code to determine a trajectory of the asset tag's movements from consecutive locations in the history; and
program code to detect an erroneous position of the asset tag when the trajectory of the asset tag's movements indicates the asset tag has moved through a barrier to reach the predetermined room.
